(19) United States
(12) Patent Application Publication
(10) Pub. No.: US 2012/0048243 A1
(43) Pub. Date: Mar. 1, 2012

(54) PRESSURE PUMP DEVICE FOR A HYBRID VEHICLE

(75) Inventors: Helmut Randoll, Vaihingen (DE); Udo Schulz, Vaihingen/Enz (DE); Juergen Biester, Boeblingen (DE)

(73) Assignee: Robert Bosch GmbH, Stuttgart (DE)

(21) Appl. No.: 13/057,523

(22) PCT Filed: Jun. 10, 2009
(86) PCT No.: PCT/EP2009/057140

§ 371 Date: Apr. 28, 2011

(30) Foreign Application Priority Data
Aug. 7, 2008 (DE) 102008041067.5

(51) Int. Cl. F02M 37/04

(52) U.S. Cl. 123/497; 180/65.28

(57) ABSTRACT

A pressure pump device for a hybrid vehicle, which is drivable by a combustion engine having a fuel pressure accumulator and by an electric drive. The pressure pump device includes a pressure pump, which is mechanically connectable to the electric drive for supplying fuel to the fuel pressure accumulator.

### FIELD OF THE INVENTION

The present invention relates to the field of hybrid vehicles.

### BACKGROUND INFORMATION

Today's hybrid vehicles are normally equipped with an electric drive and a combustion drive, for example a gasoline engine or a Diesel engine. These hybrid concepts allow for a serial, a parallel, and a power-splitting coupling of these drive units. The parallel hybrid concepts has advantages over the serial and the power-splitting hybrid concept because it allowed for already existing motor or transmission components to be used and has a high efficiency under all conditions of use at a very favorable consumption.

FIG. 2 shows a parallel hybrid vehicle having a combustion engine 201 and an electric motor and generator 203, which are each mechanically coupled to a drive train. Combustion engine 201 is supplied with a fuel contained in a tank 205 and produces by its combustion a propulsion force for driving the hybrid vehicle. In electric motor operation, a battery 207 supplies electric motor and generator 201 with electrical energy for driving the hybrid vehicle. In generator operation, electric motor and generator 203 may be used to charge battery 207 for example. Furthermore, an inverter 209 is disposed between electric motor and generator 203 and battery 207.

Modern combustion engines, which are also used in hybrid vehicles, often have a fuel pressure accumulator, also called a “rail”, which has pressurized fuel applied to it by a high-pressure pump. In today's common-rail injection systems, the high-pressure pump is flange-mounted directly or in geared-up fashion on a camshaft of the combustion engine. A mechanical coupling of the high-pressure pump to the camshaft, in particular in parallel Diesel hybrid vehicles, creates the problem, however, of maintaining the fuel pressure when the engine is switched off, for a start-stop operation for example, and to build it up when transitioning from an operation by electric motor to a hybrid operation or Diesel engine operation. For this reason it is also not possible to use and operate smaller high-pressure pumps at a higher rotational speed, because such pumps require more time for filling the fuel pressure accumulator. They furthermore achieve a maximum pressure already at an engine speed of 1,000 RPM.

For decoupling the high-pressure pump from the camshaft, another electric motor could in principle be provided. German patent document DE 100 03 736 A1 for example discusses an operating device for a combustion engine of a conventional motor vehicle having an additional electric motor, which is used to drive a fuel pump. This concept, however, is not suitable for operating a fuel pressure pump for a fuel pressure accumulator. For it would be necessary, for a 2 liter Diesel engine having four cylinders and a rated output of 105 kW for example, to provide a required mechanical drive power of circa 3 kW at about 300 Nm to generate the necessary rail pressure and the maximum rotational speed. The efficiency of a high-pressure pump is normally about 95%. Since today's generators generate about 2 kW at 12 V, another generator would have to be provided in addition to the additional electric motor on account of this limitation of the vehicle electrical system, which involves additional effort and additional costs, however. Furthermore, another control electronics and, at an estimated 150 W power loss in a control unit, another cooling would have to be provided.

### SUMMARY OF THE INVENTION

An objective of the exemplary embodiments and/or exemplary methods of the present invention is to create an efficient system for driving a high-pressure pump for applying fuel to a fuel pressure accumulator in hybrid vehicles.

This objective may be achieved by the features of the methods and/or systems described herein. Advantageous specific developments are indicated and disclosed in the further description.

The exemplary embodiments and/or exemplary methods of the present invention are based on the realization that the high-pressure pump in hybrid vehicles may be decoupled from a camshaft of the combustion engine and instead may be connected for example to a drive shaft of the electric drive and be driven by the latter.

According to the exemplary embodiments and/or exemplary methods of the present invention, the hybrid drive system is therefore extended and is also used to decouple the high-pressure pump at least at times from the camshaft of the combustion engine and to use the already existing electric drive motor of the hybrid vehicle at least in its predetermined operating states for driving the high-pressure pump. The system according to the exemplary embodiments and/or exemplary methods of the present invention may be used in particular in parallel hybrid vehicles, for example in parallel Diesel hybrid vehicles, because the high-pressure pump is able to be mechanically coupled directly to a hybrid drive train associated with the electric motor and generator of the hybrid vehicle.

An advantage of the system according to the exemplary embodiments and/or exemplary methods of the present invention is that an improved start and restart performance of a combustion engine, for example a Diesel engine, may be achieved as a result of a timely rail pressure buildup. In addition, the system according the exemplary embodiments and/or exemplary methods of the present invention contributes toward increasing the operational safety, because the high-pressure pump may be switched off independently of the operating state of the combustion engine. The operation of the high-pressure pump, according to the exemplary embodiments and/or exemplary methods of the present invention, using the electric drive motor is furthermore advantageous in a diagnosis of the high-pressure circuit comprising the high-pressure pump, the supply lines, and the fuel pressure accumulator, and furthermore allows for efficiently detecting the latter's actuating characteristic. Moreover, the disadvantages arising as a consequence of the delayed set-in of the Diesel engine when changing the operating states of the parallel Diesel hybrid due to the pressure buildup in the rail required beforehand are avoided. The system according to the exemplary embodiments and/or exemplary methods of the present invention furthermore contributes toward improving the comfort as well as the injection accuracy in current common rail injection systems.

The exemplary embodiments and/or exemplary methods of the present invention relates to a pressure pump for a hybrid vehicle, which is drivable by a combustion engine having a fuel pressure accumulator and by an electric drive. The pressure pump device includes a pressure pump, in particular a fuel pressure pump or a high-pressure pump, which is mechanically connectable to the electric drive and drivable by the latter for the purpose of supplying fuel to the fuel pressure accumulator.

According to one exemplary embodiment, the pressure pump device further includes a rotational speed changing device for lowering or increasing a rotational speed, the pressure pump being mechanically connectable by the rotational speed changing device to the electric drive, in particular to a shaft of the electric drive.

According to one exemplary embodiment, the pressure pump includes a metering unit, the pressure pump device further including a metering unit control unit, which is developed to control the metering unit for setting a fuel delivery quantity, for example a zero delivery quantity, as a function of a drive mode, in particular in an exclusively electric drive mode.

According to one exemplary embodiment, the pressure pump device further includes a diagnostic unit for detecting the performance of the pressure pump in a predetermined drive mode, in particular in a driveless mode or in an exclusively electric drive mode. The diagnostic unit is developed to detect an output pressure of the pressure pump for detecting an actuating characteristic of a metering unit of the pressure pump or for detecting an actuating characteristic of a pressure control valve of the pressure pump or for detecting an output pressure curve, in particular as a function of an electrical value, for example of a voltage or a current, of the electric drive.

According to one exemplary embodiment, the pressure pump device is developed to switch the electric drive on or switch it off in order to increase or lower the fuel pressure in the fuel pressure accumulator in particular in a coasting operating mode, in which the combustion engine is decoupled from a drive train.

According to one exemplary embodiment, the pressure pump device is developed to decouple the pressure pump from the electric drive or to switch off the electric drive and/or to open at least one pressure valve of the pressure pump if a rotational speed change of the combustion engine exceeds a predetermined threshold value. For this purpose, the pressure pump device may receive for example a rotational speed signal from a rotational speed meter or have a rotational speed meter.

The exemplary embodiments and/or exemplary methods of the present invention also relates to an electric drive device for a hybrid vehicle, which is drivable by a combustion engine having a fuel pressure accumulator and by an electric drive. The electric drive device includes an electric drive, for example an electric motor, and the pressure pump device according to the present invention for supplying fuel to the fuel pressure accumulator, the pressure pump and the pressure pump device being mechanically coupled to the electric drive, in particular to a shaft of the electric drive, and being drivable by the latter.

The exemplary embodiments and/or exemplary methods of the present invention also relates to a method for operating a pressure pump in a hybrid vehicle, which is drivable by a combustion engine having a fuel pressure accumulator and by an electric drive, including the step of mechanically coupling the pressure pump to the electric drive in order to drive the pressure pump for supplying fuel to the fuel pressure accumulator.

According to one exemplary embodiment, the method includes the step of controlling a metering unit of the pressure pump for setting a fuel delivery quantity as a function of a drive mode, in particular in an exclusively electric drive mode.

Additional method steps derive from the functionality of the pressure pump device according to the present invention.

The exemplary embodiments and/or exemplary methods of the present invention also relates to an electric drive method for a hybrid vehicle, which is drivable by a combustion engine having a fuel pressure accumulator and by an electric drive. The electric drive method includes the step of driving the hybrid vehicle and a pressure pump for supplying fuel to the fuel pressure accumulator of the combustion engine using the electric drive according to the present invention.

Additional exemplary embodiments of the present invention are explained with reference to the attached drawings.

### BRIEF DESCRIPTION OF THE DRAWINGS

FIG. 1 shows a pressure pump device.

FIG. 2 shows a basic system of a parallel hybrid.

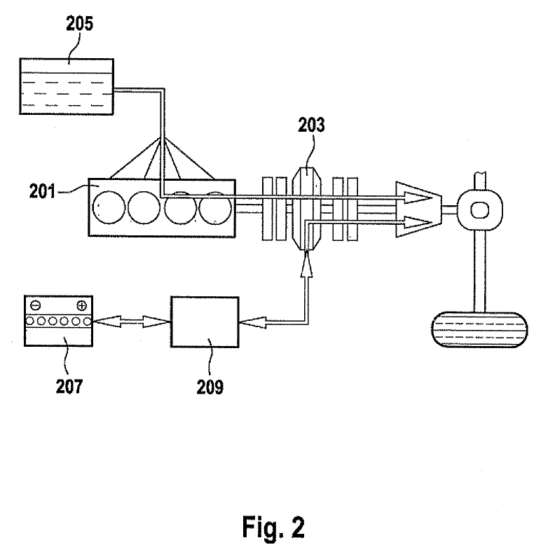

### DETAILED DESCRIPTION

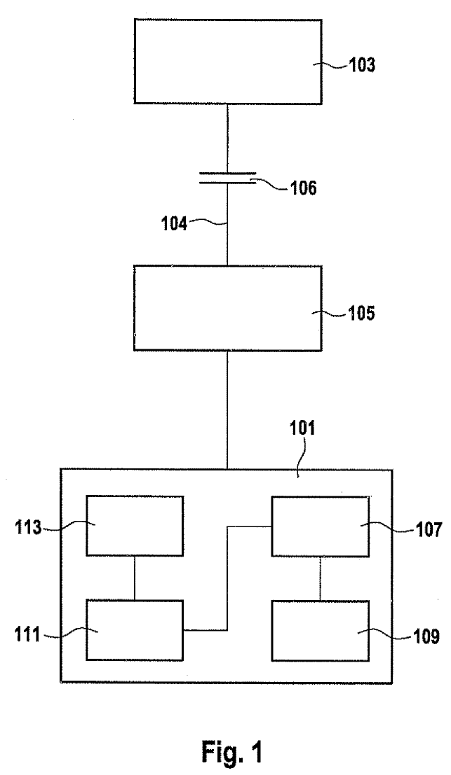

FIG. 1 shows a pressure pump device for a hybrid vehicle, in particular for a parallel hybrid vehicle, which is driven by a combustion engine, not shown in FIG. 1, having a fuel pressure accumulator. The pressure pump device includes a pressure pump 101, which is provided for supplying fuel to the fuel pressure accumulator and is mechanically coupled to an electric drive 103, for example to an electric motor. Pressure pump 101 is mechanically coupled for example to a shaft 104 of electric drive 103, a rotational speed changing device 105 being optionally provided in order to increase or preferably reduce a rotational speed of the shaft of the electric motor, in order to operate pressure pump 101 at a lower rotational speed. Rotational speed changing device 105 may be developed and provided for example on the basis of gear wheels, which lower the rotational speed for example by the factor ⅓, ¼, ⅕, ⅙, 1/7, ⅛, 1/9 or 1/10. In this manner, an adaptation of the rotational speed of the shaft of electric drive 103 may be adapted to a characteristic of pressure pump 101. Pressure pump 101 may be designed for example for high pressures of 1000 bar, 2000 bar or 3000 bar. Optionally, another clutch 106 may be provided between electric drive 103 and rotational speed changing device 105.

Pressure pump 101 may further include a metering unit 107 for setting a fuel delivery quantity and a metering unit control unit 109 for controlling metering unit 107. Fuel pressure pump 101 may also have a diagnostic unit 111 as well as at least one pressure control valve 113. Diagnostic unit 111 is provided for example to detect an actuating characteristic of metering unit 107 or of pressure control valve 113 and on this basis set for example an operating point of metering unit 107 and/or of pressure control valve 113 for example adaptively.

According to one aspect, electric drive 103, for example an electric motor and generator, and pressure pump 101 form an electric drive device for a hybrid vehicle having the additional elements optionally shown in FIG. 1. In this instance, shaft 104 of electric drive 103 drives both pressure pump 101 as well as the hybrid vehicle, for example a parallel Diesel hybrid vehicle.

In hybrid vehicles, in particular in parallel Diesel hybrids having a common rail injection system, different drive modes may be differentiated, which are respectively characterized by a different operation of the electric drive and the combustion drive. In a generator mode, the electric drive is used to charge the energy stores. In a recuperation mode, the electric drive may be used for example as an electric generator brake including an energy recovery. In a so-called boost mode, both the electric motor and the combustion engine drive the hybrid vehicle. Furthermore, electric driving is possible while a combustion engine is driven externally. In an electric driving mode, the hybrid vehicle is driven exclusively electrically. Furthermore, a coasting operating mode should be mentioned, in which the combustion engine is mechanically separated from a drive train.

According to the exemplary embodiments and/or exemplary methods of the present invention, when driving exclusively by combustion engine, only the combustion engine drives the hybrid vehicle such that a clutch of the combustion engine and a transmission clutch are closed. With respect to the high pressure generation, this operating state does not differ from a conventional drive train of a combustion engine having a common rail injection system and a high-pressure pump installed on the camshaft. In the boost mode, the combustion engine and the electric motor drive the hybrid vehicle, the clutch of the combustion engine and the clutch of the transmission being closed. In this state as well, the high pressure generation does not differ from conventional drive train systems.

In the electric drive mode, both the hybrid vehicle as well as pressure pump 101 are driven by electric motor 103, while the combustion engine is switched off. In this mode, the clutch of the combustion engine is open and the transmission clutch is closed. So as not to impede an electric start additionally by a torque requirement of pressure pump 101, pressure pump 101 in this driving phase may be operated at a zero delivery on the part of metering unit 107. If a predetermined driving speed or a predetermined rotational speed of the electric motor is reached, then, according to the present invention, the fuel pressure in the rail may already be built up prior to starting the combustion engine.

In this transition from driving by electric motor to driving for example by Diesel engine, the Diesel engine is started, while the diesel engine clutch and the transmission clutch are closed. In a first drive phase, electric motor 103 drives the hybrid vehicle, while the Diesel engine is switched off. While in a Diesel engine start, for example in a restart or at the beginning of a driving cycle, a rail pressure of 150-200 bar is sufficient, the fuel pressure for a reinstatement of the Diesel engine depends on a current operating point of the hybrid vehicle. In order to reduce undesired acoustic effects such as engine knocking due to an excessively high rail pressure when reinstating the Diesel engine, a somewhat lower rail pressure may be set prior to reinstating the Diesel engine.

In the coasting operating mode, the Diesel engine clutch and the transmission clutch are open. In this operating state, a diagnosis of pressure pump 101 may be performed, assuming that only the high-pressure pump is coupled to electric motor and generator 103 and that the influence of additional components on the torque is known or that these may be switched off. For this purpose, pressure pump 101 may be operated by electric motor 103, it being possible to measure a current and a voltage of electric motor 103 and a rail pressure curve in a rail (not shown in FIG. 1) for example at a predetermined sampling frequency. From the current curve and/or the voltage curve as well as from the rail pressure curve, information may be determined regarding the drift, the leakage or regarding the high pressure range defects on the basis of a comparison with predetermined setpoint values. In particular, information may be derived about an actuator of metering unit 109 and of pressure control valve 113, regarding pressure pump 101 and its pump elements and regarding the fuel lines. In this manner, it is possible for example to determine a quantitative balance and an efficiency of pressure pump 101.

In addition, in the coasting operation, it is also possible to detect the actuating characteristics of metering unit 109 and of pressure control valve 113. To determine the actuating characteristic of pressure control valve 113, high-pressure pump 101 may build up the rail pressure for example in an injection-free state, it being possible to detect the actuating characteristic of pressure control valve 113 on the basis of different electrical pulse control factors regarding the pressure buildup and its measurement.

To detect the actuating characteristic of metering unit 109, high-pressure pump 101 may build up the rail pressure, for example at a constant rotational speed of electric motor 103 and for example in an injection-free state, at different electrical pulse control factors of metering unit 109. The actuating characteristic of metering unit 109 may be detected via the pressure buildup curve and its measurement. For this purpose, pressure control valve 113 may be closed. In addition, the influence of the fuel temperature may also be taken into account by a measurement for example.

Fundamentally, it is also possible to detect a relationship between a fuel injection quantity and an electrical control time of an injector. For this purpose, the delivery may be switched off for example after the pressure has been built up in the rail and only one injector operated at a specific electrical control time. The injected quantity may be estimated for example on the basis of the pressure drop comparison. In order to eliminate the influence of leakages in the high-pressure circuit, the high-pressure circuit may in advance be brought for example to a high pressure of 1,000 bar for example, without opening the injectors and actuators on the high-pressure circuit. The pressure curve is then a measure for the leakage in the high-pressure circuit, which may be taken into account when determining a relationship between the injection quantity and the electrical control time, for example by a subtraction. Furthermore, the control quantity of each individual injector may be ascertained. For this purpose, the electrical control time may be reduced to such an extent that no injections occur, a fact that may be detected for example on the basis of the Diesel engine speed. The pressure drop in the high-pressure circuit minus the leakage of the components on the high-pressure circuit then yields the control quantity to be determined.

For example, electric motor and generator 103 may be disconnected both from the transmission and from the combustion engine and switched on when needed in order to compensate for a pressure drop in the rail or to build pressure up in accordance with a desired load profile prior to reinstating the combustion engine. In addition, for example in coasting operation, a redundant switch-off of the combustion engine may be performed, if for example an undesired acceleration is detected for example via a high rotational speed change. In this case, both clutches may be opened, electric motor 103 may be switched off, and pressure valve 113 or multiple pressure valves may be opened. The decoupling of high-pressure pump 101 from the combustion engine thus makes it possible to prevent an undesired increase in the engine speed and thus an “over-revving” of the engine.

In the generator mode, the combustion engine clutch is closed and the transmission clutch is open. In this operating mode, the battery is charged, the connection of high-pressure pump 101 to the combustion engine corresponding for example to the conventional drive train. The load-dependent pressure buildup in the rail as well as the pressure maintenance function may be implemented by a suction control in metering unit 107.

In the recuperation mode, the Diesel engine clutch is open and the transmission clutch is closed. In this operating mode, the battery is charged via electric drive 103 driven by the transmission-side drive train. The load-dependent pressure buildup in the rail and the pressure maintenance function may also be implemented in this operating mode by the suction control in metering unit 107.

When the Diesel engine clutch is closed and the transmission clutch is closed, the Diesel engine is operated in an overrun condition. In this operating mode, a friction power of the engine in the overrun condition is additionally used to decelerate the vehicle. The load-dependent pressure buildup in the rail and the pressure maintenance function may also be implemented in this operating mode by a suction control in metering unit 107.

The system according to the exemplary embodiments and/or exemplary methods of the present invention may be used both for gasoline injection systems as well as for Diesel injection systems that operate according to the common rail principle. For this reason, the exemplary embodiments described above in connection with a Diesel engine also apply analogously to gasoline engines or to gasoline-Diesel engines.

1-10. (canceled)

11. A pressure pump device for a hybrid vehicle, which is drivable by a combustion engine having a fuel pressure accumulator and by an electric drive, comprising:
a pressure pump that is mechanically connectable to the electric drive for supplying fuel to the fuel pressure accumulator.

12. The pressure pump device of claim 11, further comprising:
a rotational speed changing device for lowering or increasing a rotational speed, wherein the pressure pump is mechanically connectable by the rotational speed changing device to the electric drive, in particular to a shaft of the electric drive.

13. The pressure pump device of claim 11, further comprising:
a metering unit control unit to control a metering unit of the pressure pump for setting a fuel delivery quantity as a function of a drive mode, in particular in the exclusively electric drive mode.

14. The pressure pump device of claim 11, further comprising:
a diagnostic unit for detecting the performance of the pressure pump in a predetermined drive mode, in particular in a coasting operating mode or in an exclusively electric drive mode, wherein the diagnostic unit is configured to detect an output pressure of the pressure pump for detecting an actuating characteristic of a metering unit of the pressure pump or for detecting an actuating characteristic of a pressure control valve of the pressure pump or for detecting an output pressure curve, in particular as a function of an electrical value of the electric drive.

15. The pressure pump device of claim 11, wherein it is configured to switch on or switch off the electric drive to increase or lower the fuel pressure in the fuel pressure accumulator, in particular in a coasting operating mode.

16. The pressure pump device of claim 11, wherein it is configured to decouple the pressure pump from the electric drive or to switch off the electric drive or at least to open a pressure valve of the pressure pump if a rotational speed change of the combustion engine exceeds a predetermined threshold value.

17. An electric drive device for a hybrid vehicle, which is drivable by a combustion engine having a fuel pressure accumulator and by an electric drive, comprising:
an electric drive; and
the pressure pump device for supplying fuel to the fuel pressure accumulator, wherein the pressure pump device includes a pressure pump that is mechanically connectable to the electric drive for supplying fuel to the fuel pressure accumulator;
wherein the pressure pump is mechanically coupled to the electric drive, in particular to a shaft of the electric drive, and being drivable by the latter.

18. A method for operating a pressure pump in a hybrid vehicle, which is drivable by a combustion engine having a fuel pressure accumulator and by an electric drive, the method comprising:
mechanically coupling the pressure pump to the electric drive to drive the pressure pump for supplying fuel to the fuel pressure accumulator; and
supplying fuel to the fuel pressure accumulator.

19. The method for operating the pressure pump of claim 18, further comprising:
controlling a metering unit of the pressure pump for setting a fuel delivery quantity as a function of a drive mode.

20. An electric drive method for a hybrid vehicle, which is drivable by a combustion engine having a fuel pressure accumulator and by an electric drive, the method comprising:
using an electric drive to drive the hybrid vehicle and a pressure pump for delivering fuel to the fuel pressure accumulator of the combustion engine, wherein the electric drive is driven by mechanically coupling the pressure pump to the electric drive to drive the pressure pump for supplying fuel to the fuel pressure accumulator.
